(19) United States
(12) Patent Application Publication
(10) Pub. No.: US 2011/0204580 A1
(43) Pub. Date: Aug. 25, 2011

(54) MULTILAYER GASKET WITH LABYRINTH STOPPER

(75) Inventor: Bhawani Tripathy, Ann Arbor, MI (US)

(73) Assignee: FEDERAL-MOGUL CORPORATION, Southfield, MI (US)

(21) Appl. No.: 13/030,179

(22) Filed: Feb. 18, 2011

Related U.S. Application Data
(60) Provisional application No. 61/306,093, filed on Feb. 19, 2010.

(51) Int. Cl. F02F 11/00

(52) U.S. Cl. 277/593

(57) ABSTRACT

A multilayer metal gasket (40) having first (28) and second (30) functional layers. Each layer (28, 30) includes an opening (34, 38) for sealing a fluid passage or combustion chamber. Each layer (28, 30) includes a folded lip or rim (50, 52) bent in opposite directions and overlapping one another in a nested configuration to form a labyrinth which serves also as the compression stopper feature for the gasket assembly (40). Sealing beads (42, 44) are formed in each layer (28, 30) and, preferably, are arranged to contact each other in crest-to-crest orientation to perfect a seal.

### CROSS REFERENCE TO RELATED APPLICATIONS

This application claims priority to Provisional Patent Application No. 61/306,093 filed Feb. 19, 2010, the entire disclosure of which is hereby incorporated by reference and relied upon.

### BACKGROUND OF THE INVENTION

1. Field of the Invention

This invention relates to multilayer gaskets, and more particularly to those including a stopper for limiting compression height of the gasket when installed between two mating surfaces.

2. Related Art

Multilayer metal gaskets, also referred to as multilayer steel (MLS) gaskets, are commonly used in static sealing applications that require a fluid-tight seal to be created around a passage shared by two mating members. For example, an MLS gasket, generally indicated at 20 in FIG. 1, may be clamped between a cylinder head 22 and an engine block 24 to perfect a combustion seal around multiple combustion chambers as well as around oil and lubrication passages shared by the two mating members 22, 24. However, multilayer metal gaskets can also be used in other applications, such as to seal an exhaust manifold to an engine block, as well as other engine and non-engine applications. An enlarged view of a prior art multilayer gasket 20 is shown in FIG. 2. Frequently, cylinder head gaskets 20 like that shown in FIGS. 1 and 2 include multiple bore openings to correspond with multiple cylinders in an engine block 24. The narrow region between adjacent openings is called a bridge portion 26. In traditional multilayer gasket applications, the bridge portion 26 can be a difficult area to seal. The constant transition between compression and expansion in adjacent cylinders creates substantial cyclic pressure differentials that are difficult to contain with a narrow strip of gasket 20. As a result, it is common for some combustion gases to leak through the multiple layers of the gasket 20, particularly in the bridge portion 26, resulting in some loss of engine efficiency.

Multilayer gaskets are particularly useful in applications which require a minimal thickness gasket capable of sealing effectively under fairly low and/or highly variable contact pressures. US Publication No. 2005/0189724, assigned to the assignee of this invention, the entire disclosure of which is hereby incorporated by reference, discloses a multilayer metal gasket including first and second functional layers formed with respective openings that coincide with a cylinder chamber. The functional layers include opposed sealing beads around the opening, together with an interposed stopper layer serving as a compression limiting feature to establish a final, i.e., fully compressed, assembled height.

One shortcoming in many prior art multilayer gasket designs may be attributed to the combustion gas leak paths which can easily form at the exposed edges of the stacked functional layers as they terminate around the opening for the combustion chamber or other flow passage shared between the mating surfaces. Combustion gases are typically held at bay by the compression stopper, sealing beads and other compacted layers of the gasket. However, as combustion pressures fluctuate and vibrations propagate, minor separations in the gasket layers may enable a momentary but recurring leak path for hot combustion gases, resulting in a decrease in engine efficiencies. Furthermore, the cost of multilayer gaskets is always a concern; lower cost designs are sought after. For all of these reasons and others, there is a need in the art for new and improved multilayer gaskets that will overcome the shortcomings inherent in prior art designs and provide better sealing of combustion gases with minimal increase in cost or fabrication complexity.

### SUMMARY OF THE INVENTION

A multi-layered gasket assembly is provided of the type for clamping between mating members to perfect a fluid-tight seal around a passage shared by the mating members. The gasket assembly includes a first functional layer comprising a generally planar body having a generally uniform thickness. The first layer has a first opening therein for sealing around the shared passage extending between the two mating members. Similarly, a second functional layer comprises a generally planar body having a generally uniform thickness and a second opening therein for sealing around the shared passage. The first and second layers overlie one another so that their respective first and second openings are generally aligned along a laterally extending axis. The assembly includes at least one sealing bead spaced apart from the first opening. The first layer includes a first rim directly adjacent and surrounding the first opening. The first rim extends laterally from the planar body of the first layer to a first terminal edge. The first rim has a first rim height measured laterally at the first opening. The second layer includes a second rim directly adjacent and surrounding the second opening. The second rim extends laterally from the planar body of the second layer to a second terminal edge and has a rim height measured laterally at the second opening. The first rim closely surrounds the second rim in a nested relationship to form a labyrinth stopper.

The labyrinth stopper of this subject invention, formed by the nesting first and second rims, creates a tortuous path for combustion gases which resist the leakage of fluid, particularly between the gasket layers and even in conditions where vibration and cyclic pressure fluctuations may cause minor separations between the gasket layers. As a result, the gasket assembly of this invention improves performance of the gasket assembly. Furthermore, the labyrinth stopper is simple to manufacture using known construction techniques and can, in preferred embodiments, be formed integrally from the base material used to manufacture the respective first and second functional layers. This, therefore, can be accomplished without welding or otherwise affixing separate stopper layers or by other more complicated fabrication techniques.

### BRIEF DESCRIPTION OF THE DRAWINGS

These and other features and advantages of the present invention will become more readily appreciated when considered in connection with the following detailed description and appended drawings, wherein:

FIG. 1 shows a prior art engine assembly partially exploded with multilayer gasket disposed between an engine block and cylinder head;

FIG. 2 is an enlarged, fragmentary view of a multilayer cylinder head gasket according to the prior art;

FIG. 3 is a fragmentary, cross-sectional view of a gasket assembly according to the subject invention including the novel labyrinth stopper feature;

FIGS. 4A-C show a progression of assembly for the first and second functional layers of a gasket manufactured according to one embodiment of this invention and highlighting the relative heights of the first and second rims;

FIG. 5 is an enlarged, perspective view as in FIG. 4C;

FIG. 6 is a fragmentary view of a gasket assembly according to this invention including a pair of side-by-side openings, with the second functional layer shown in partial cross-section through the bridge portion of the gasket;

FIG. 7 is an enlarged, cross-sectional view of the bridge portion of the subject gasket assembly and illustrating a tortuous gas leakage path created by the labyrinth stopper;

FIG. 8 is a cross-sectional view of an alternative embodiment of this invention including an intermediate shim layer disposed between the first and second layers;

FIG. 9 is a cross-sectional view showing another alternative embodiment of this invention including a supplemental member disposed between the labyrinth stopper and sealing bead of the second layer;

FIG. 10 is a view as in FIG. 9 showing an alternative placement for the optional supplemental member on the first layer;

FIG. 11 is a cross-sectional view showing a still further alternative embodiment of this invention wherein the first and second layers are provided with an optional elastomer coating and the sealing beads are arranged to face away from one another; and

FIG. 12 is an alternative embodiment of the subject invention showing the second rim of the second layer having an undulating profile.

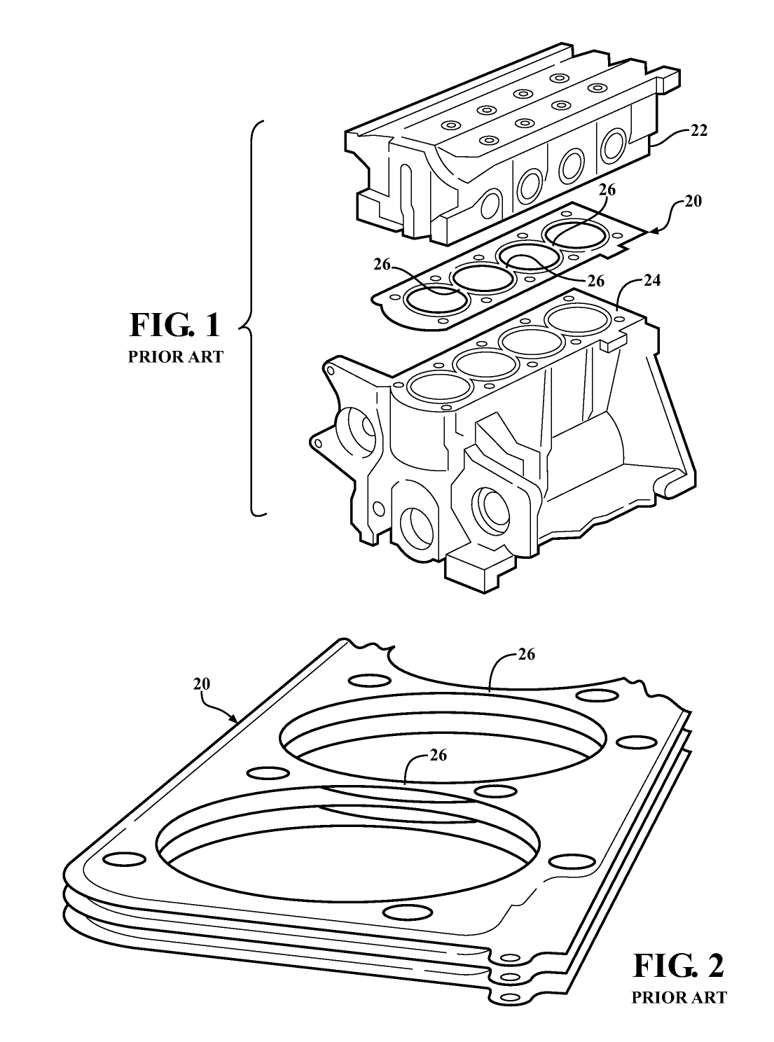

### DETAILED DESCRIPTION OF THE PREFERRED EMBODIMENT

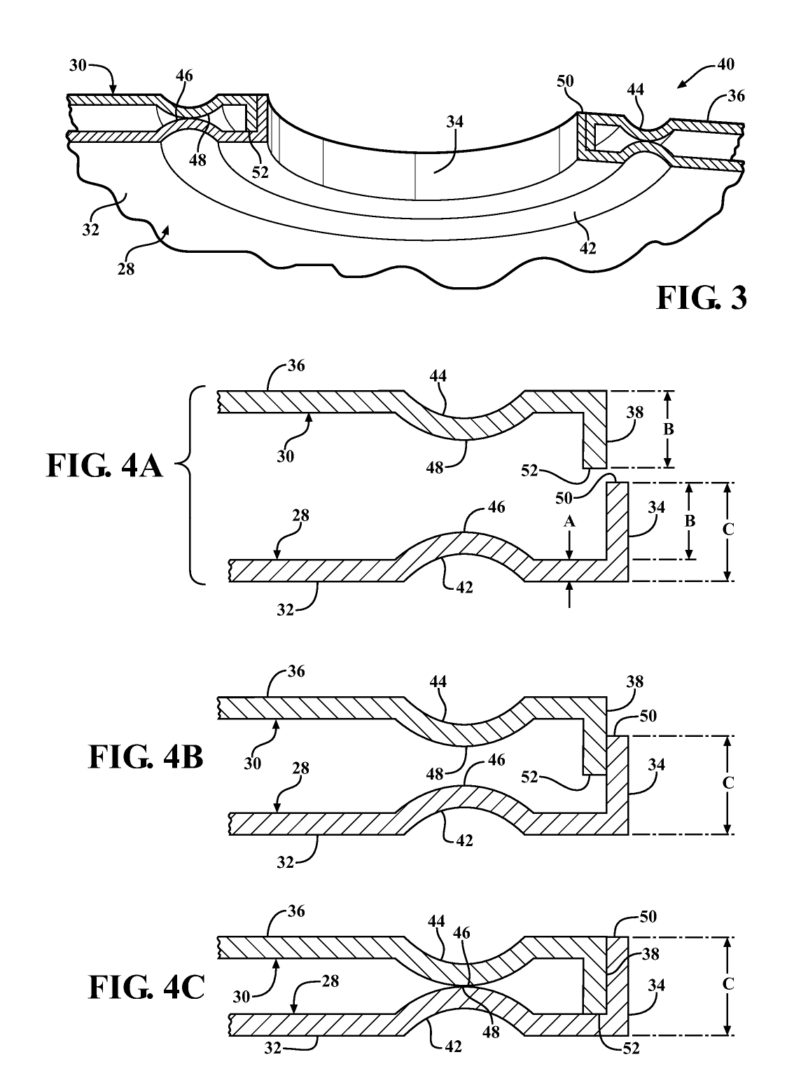

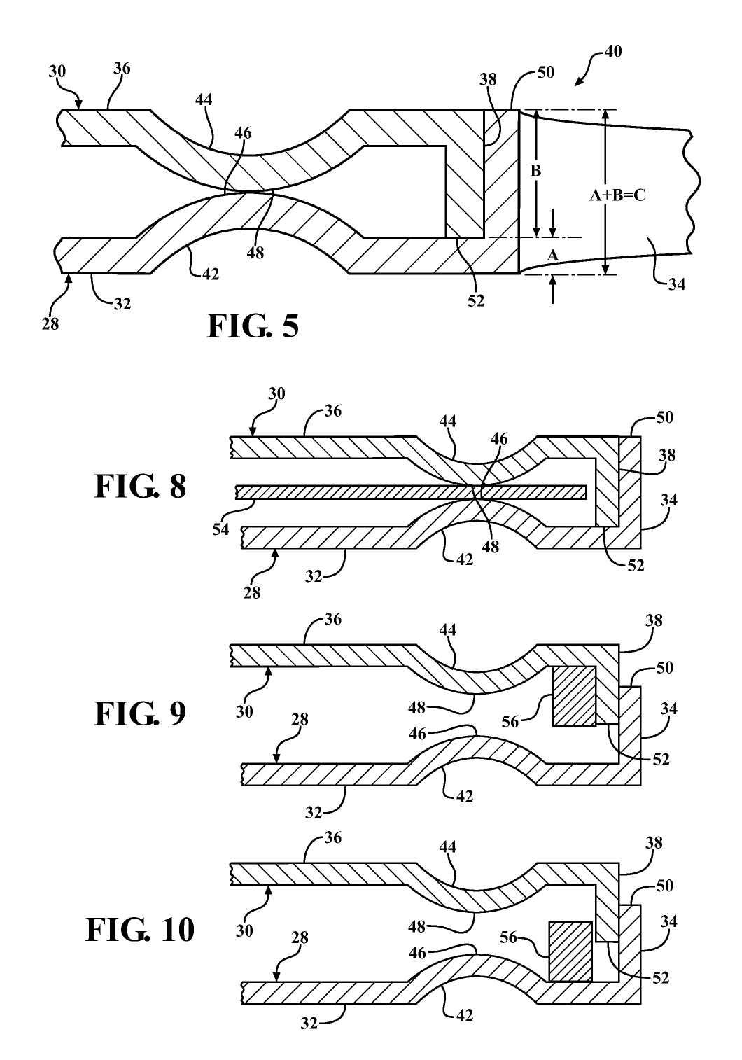

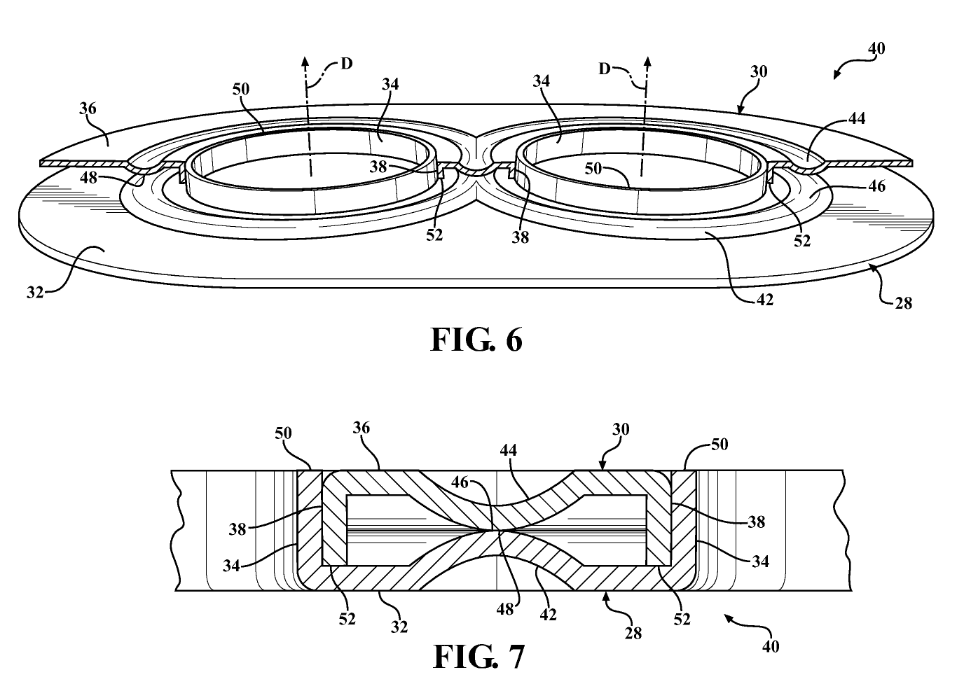

Referring to the figures wherein like numerals indicate like or corresponding parts throughout the several views, a multilayer gasket according to this invention is generally showing at 40 in FIGS. 3-10. A preferred embodiment is shown in FIGS. 3-7 including a first functional layer, generally indicated at 28, and a second functional layer, generally indicated at 30. The first layer 28 comprises a generally planar body 32 having a generally uniform thickness A (see FIGS. 4A and 5). A first opening 34 is formed in the first layer 28 for sealing around a shared passage between the two mating members to be sealed, such as around a combustion opening between a cylinder head and a cylinder block. The second functional layer 30 may be similar in construction to the first layer 28 and also comprises a generally planar second body 36 and a second opening 38. Assembled together as a unit, the first 28 and second 30 layers form the gasket assembly. In the assembly 40, the first 28 and second 30 layers overlie one another such that the respective first 34 and second 38 openings are generally aligned. In cases where the openings 34, 38 can be defined relative to an axis, such as for circular or oval formations, the two layers 28, 30 may be said to be aligned along a laterally extending axis. In the example of a gasket assembly 40 used to seal a cylinder head in an engine, the axis D will coincide with the bore axis of the combustion chamber, as shown in FIG. 6.

The gasket assembly 40 includes at least one, but preferably at least two, sealing beads 42, 44 encircling the openings 34, 38. The sealing beads 42, 44 may be carried on intermediate or non-functions layers of the gasket assembly 40, but more preferably are disposed on the first 28 and second 30 layers. The sealing beads 42, 44 may be formed integrally or formed separately and attached as shown in the figures. Preferably both sealing beads 42, 44 oppose one another and work in concert to enhance the sealing functionality of the gasket assembly 40. In particular, the first layer 28 includes an integrally formed first sealing bead 42 spaced apart from the first opening 34, and the second layer 30 includes a second sealing beat 44 spaced apart from its second opening 38. In situations where the respective openings 34, 38 are circular, as is typical in cylinder head gasket applications for example, the sealing beads 42, 44 are also preferably circular although other geometries are certainly possible. When viewed in cross-section as in FIGS. 4A-C, the sealing beads 42, 44 in this embodiment are shown to have a semi-circular shape, each including a crest 46, 48, respectively. The crest 46 of the first sealing bead 42 is laterally offset from the planar body 32. The lateral offset is measured in the direction of the axis D. Likewise, the crest 48 of the second sealing bead 44 is laterally offset from the second planar body 36. In the preferred embodiment, the first sealing bead 42 is laterally offset from the first layer 28 in a direction opposite to that of the second sealing bead 44, and more particularly the two sealing beads 42, 44 are arranged so that their respective crests 46, 48 touch one another in the space between the layers 28, 30, as shown in FIGS. 3, 4C and 5.

In FIGS. 3-5, the first layer 28 is shown including a first rim 50 directly adjacent to and surrounding the first opening 34. The first rim 50 extends laterally, i.e., in the direction of axis D, from the planar body 32 a distance C corresponding to a first rim height measured laterally along the first opening 34. The first rim height C is shown in FIGS. 4A-C. The second layer 30 includes a second rim 52 directly adjacent to and surrounding the second opening 38. The second rim 52 extends laterally from the planar body 36 of the second layer 30 a distance B corresponding to a second rim height as measured laterally along the second opening 38. The second rim height B is illustrated in FIGS. 4A and 5.

As shown in the drawings, the dimensions of the first rim 50 are larger than the dimensions of the second rim 52 so that when brought together into an assembled gasket 40, as shown in FIGS. 3, 4C and 5, the first rim 50 will closely surround the second rim 52 in a nested relationship to form a labyrinth stopper. More particularly, the dimensional relationships between the rims 50, 52 and the first layer thickness A are such that the first rim height C is substantially equal to the second rim height B plus the planar body thickness A of the first layer 28. This relationship (C=A+B) is shown quite clearly in FIGS. 4A and 5. As a result, the combination of rims 50, 52 arranged in this fashion form a stopper for the gasket assembly 40. A stopper, as will be readily apparent to those of skill in the art, is commonly used in gasket applications, including cylinder head gaskets but other applications as well, to take up a clamping load so that the sealing beads 42, 44 are not over-compressed and remain spring-like to react under normal operating conditions. In this invention, the rims 50, 52 acting together create a labyrinth design which makes it more difficult for gases to escape even if the layers 28, 30 shift laterally under fluctuating pressures and vibrations in use.

As perhaps best shown in FIGS. 6 and 7, the labyrinth feature of this invention can be particularly advantageous in applications where two side-by-side openings are formed in the gasket assembly 40, such as when sealing a multi-cylinder engine cylinder head, or when sealing multiple ports in a manifold which are arranged closely together. In these situations, the narrow region of gasket material between adjacent openings, known generally as the bridge portion, is sometimes difficult to seal particularly in view of the fact that the pressure differential between the adjacent openings may be quite substantial and fluctuate rapidly. FIG. 7 shows, by way of broken line arrows, the tortuous path created by the labyrinth design of this invention through which combustion gases, in this particular example, are forced to navigate when migrating between the layers 28, 30 in the gasket assembly 40. It will be evident that the labyrinth design of the stopper portion of the subject gasket assembly 40 is particularly effective at improving combustion gas sealing, or for other sealed high pressure or low pressure fluids and gases. The labyrinth design is effective because it creates a drastic pressure drop as high pressure gases, sometimes also at high temperatures, try to flow through the labyrinth. Designs of this nature can be expected to function much better at lower clamp loads. Furthermore, the design and construction of the subject gasket assembly 40 presents major commercial advantages in that it can be manufactured at a relatively lower cost than, for example, laser welded stopper gaskets and with lower tooling costs than most prior art designs.

Accordingly, the labyrinth stopper design of this invention, established by the nested, overlapping rims 50, 52, presents a difficult path for combustion gas or other fluids to leak around. The designs illustrated in FIGS. 3-7 represent but one exemplary embodiment. Those of skill in the art will readily appreciate alternative design opportunities, for examples the ones illustrated in FIGS. 8-13.

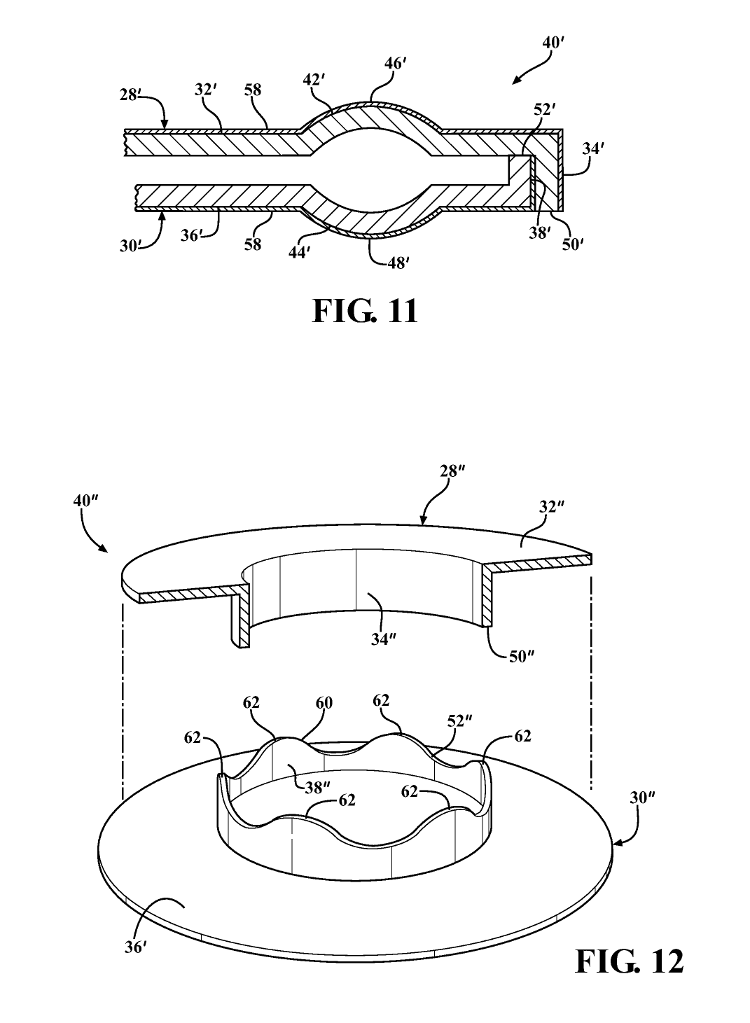

In the example of FIG. 8, the gasket assembly 40 is shown including a shim layer 54. Of course, multiple shims and even additional functional layers (not shown) may be included using principles known in the art. FIG. 9 illustrates another variation of the subject gasket assembly 40 including a supplemental member 56 attached to the second functional layer 30 between the second sealing bead 44 and the second rim 52. The supplemental member 56 can be either incompressible and cooperate in the stopper function, or alternatively compressible and serve to further enhance the sealing capabilities of the gasket assembly 40. For example, the supplemental member 56 may be used as a backstop to the labyrinth design created by the first 50 and second 52 rims to further impede fluid leakage in operation. FIG. 10 shows a still further alternative design, similar to that of FIG. 9, but wherein the supplemental member 56 is associated with the first layer 28 rather than the second layer 30.

FIG. 11 illustrates an alternative embodiment of the subject invention, wherein reference numerals are used with prime designations to illustrate like or corresponding parts to the preceding embodiments. In this example, the sealing beads 42′, 44′ extend outwardly from one another so that their respective crests 46′, 48′ do not touch one another even when compressed between mating surfaces. Also in this example, the first layer 28′ is shown arranged on the top side of the gasket assembly 40′ with the second layer 30′ forming a bottom surface of the gasket assembly 40′. Also shown in this example is an optional elastomer coating 58 which may be applied to the gasket consistent with known techniques, such as described more fully in the previously mentioned US Publication No. 2005/0189724.

Of course, the various alternative configurations shown throughout all of the figures can be used almost interchangeably to create a wide variety of gasket constructions still within the scope of the invention. It should be noted that the relationship between first C and second B rim heights can also be altered so that the equation A+B=C does not necessarily apply. For example, either of the first or second rim heights C, B can be extended slightly so that that particular rim 50, 52 functions alone as the stopper feature instead of both rims 50, 52 acting in concert. For example, if the second rim height B is shortened, it will not make contact with the planar body 32 of the first functional layer when the gasket assembly 40 is fully compressed in use. In this example, the first rim 50 alone serves as the stopper feature for the gasket, perhaps in combination with a supplemental member 56 as shown in FIGS. 9 and 10. Alternatively, if the first rim height C is shortened slightly, then the second rim 52 will contact the first planar body 32 when compressed and alone serve as a stopper feature, possibly in combination with a supplemental member 56. Thus, while in the preferred embodiment both rims 50, 52 cooperate together to form a stopper, either can act alone in some contemplated embodiments of this invention.

Furthermore, as shown in FIG. 12, a second rim 52″ can be formed with an undulating profile 60 with its alternating peaks 62 establishing the second rim height. In this example reference numerals corresponding to parts in preceding embodiments are signified with double-prime designations. The undulating profile 60 is shown having a generally sinusoidal configuration in FIGS. 12 and 13 which is highly exaggerated for clarity. Of course, a similar construction may be established by creating an undulating profile on the first rim 52″.

The labyrinth design of the subject invention is created by folding the two functional layers 28, 30 in opposing directions to create respective rims 50, 52 as shown in the figures. When assembled, the rims 50, 52 mesh within each other and serve as a combined stopper and labyrinth barrier to the leakage of fluids. When compressed, the thickness of the rims 50, 52, or of at least one rim acting alone, will take up the clamping load as well as present a leading seal interface to the fluids, which may comprise combustion gases through the labyrinth. As a result, a particular advantage of this concept relates to its ability to provide sealing even when the clamped members, for example a cylinder head and block, lift significantly in operation.

The foregoing invention has been described in accordance with the relevant legal standards, thus the description is exemplary rather than limiting in nature. Variations and modifications to the disclosed embodiment may become apparent to those skilled in the art and fall within the scope of the invention. For example, one or both sealing beads 42, 44 could be located on different layers from the labyrinth stopper features 50, 52. As an example, the sealing beads 42, 44 might be formed as parts of two intermediate layers 54. Many other variations are also certainly possible and within the spirit and scope of this invention.

What is claimed is:

1. A multi-layered gasket assembly (40) of the type for clamping between mating members to perfect a fluid-tight seal around a passage shared by the mating members, said gasket assembly (40) comprising:
a first functional layer (28) comprising a generally planar body (32) having a generally uniform thickness (A); said first layer (28) having a first opening (34) therein for sealing around the shared passage extending between the two mating members;
a second functional layer (30) comprising a generally planar body (36) having a generally uniform thickness; said second layer (30) having a second opening (38) therein for sealing around the shared passage;
said first (28) and second (30) layers overlying one another such that said respective first (34) and second (38) openings are generally aligned along a laterally extending axis (D);
at least one sealing bead (42, 44) spaced apart from said respective opening (34, 38);
said first layer including (28) a first rim (50) directly adjacent and surrounding said first opening (34); said first rim (50) extending laterally from said planar body (32) of said first layer (28) to a first terminal edge; said first rim (50) having a first rim height (C) measured laterally at said first opening (34);
said second layer (30) including a second rim (52) directly adjacent and surrounding said second opening (38); said second rim (52) extending laterally from said planar body (36) of said second layer (30) to a second terminal edge; said second rim (52) having a second rim height (B) measured laterally at said second opening (38);
said first rim (50) closely surrounding said second rim (52) in a nested overlapping relationship to form a labyrinth stopper.

2. The gasket assembly (40) of claim 1, wherein said first rim height (C) is greater than said second rim height (B).

3. The gasket assembly (40) of claim 2, wherein said first rim height (C) is substantially equal to said second rim height (B) plus said planar body thickness (A) of said first layer (28).

4. The gasket assembly (40) of claim 1, wherein said second terminal edge of said second rim (52) has an undulating profile (60).

5. The gasket assembly (40) of claim 1, wherein said first and second openings (34, 38) are each fully included within said respective first (28) and second (30) layers.

6. The gasket assembly (40) of claim 5, wherein said first layer (28) includes an integrally formed first sealing bead (42) spaced apart from said first opening(34); and said second layer (30) includes an integrally formed second sealing bead (44) spaced apart from said second opening (38).

7. The gasket assembly (40) of claim 6, wherein said first sealing bead (42) includes a crest (46) laterally offset from said planar body (32) of said first layer (28); and said second sealing bead (44) includes a crest (48) laterally offset from said planar body (36) of said second layer (30).

8. The gasket assembly (40) of claim 7, wherein said first sealing bead (42) is laterally offset from said first layer (28) in a direction opposite to the lateral offset of said second sealing bead (44) relative to said second layer (30).

9. The gasket assembly (40) of claim 8, wherein said crests (46, 48) of said respective first (42) and second (44) sealing beads are in direct touching contact with one another.

10. The gasket assembly (40) of claim 1, wherein at least one of said first (28) and second (30) layers are fabricated from a steel material.

11. The gasket assembly (40) of claim 1, wherein said first (28) and second (30) layers are fabricated from a metallic material.

12. The gasket assembly (40) of claim 1, wherein at least one of said first (28) and second (30) layers includes an elastomer coating (58) covering one side thereof.

13. The gasket assembly (40) of claim 1, wherein at least one intermediate layer (54) is disposed between said first (28) and second (30) layers.

14. A multi-layered cylinder head gasket assembly (40) of the type for clamping between an engine block (24) and cylinder head (22) in an engine to perfect a fluid-tight seal around a combustion chamber, said gasket assembly (40) comprising:
a first functional layer (28) comprising a generally planar body (32) having a generally uniform thickness (A), said first layer (28) fabricated from a metallic material; said first layer (28) having a fully included first opening (34) therein for sealing around a combustion chamber;
a second functional layer (30) comprising a generally planar body (34) having a generally uniform thickness, said second layer (30) fabricated from a metallic material; said second layer (30) having a fully included second opening (38) therein for sealing around the combustion chamber;
said first (28) and second (30) layers disposed side-by-side and overlying one another such that said respective first (34) and second (38) openings are generally aligned;
said first layer (28) including a first sealing bead (42) spaced apart from said first opening (34); said first sealing bead (42) including a crest (46) laterally offset from said planar body (32) of said first layer (28);
said second layer (30) including a second sealing bead (44) spaced apart from said second opening (38); said second sealing bead (44) including a crest (48) laterally offset from said planar body (36) of said second layer (30);
said first sealing bead (42) being laterally offset from said first layer (28) in a direction opposite to the lateral offset of said second sealing bead (44) relative to said second layer (30); said crests (46, 48) of said respective first (42) and second (44) sealing beads in direct touching contact with one another;
said first layer (28) including a first rim (50) directly adjacent and surrounding said first opening (34); said first rim (50) extending laterally from said planar body (32) of said first layer (28) to a first terminal edge; said first rim (50) having a first rim height (C) measured axially at said first opening (34);
said second layer (30) including a second rim (52) directly adjacent and surrounding said second opening (38); said second rim (52) extending laterally from said planar body (36) of said second layer (30) to a second terminal edge; said second rim (52) having a second rim height (B) measured axially at said second opening (38); and
said first rim (50) closely surrounding said second rim (52) in an overlapping nested relationship to form a labyrinth stopper.

15. The gasket assembly (40) of claim 14, wherein at least one of said first (28) and second (30) layers includes an elastomer coating (58) covering one side thereof.

16. The gasket assembly (40) of claim 14, wherein at least one intermediate layer (54) is disposed between said first (28) and second (30) layers.

17. A multi-layered cylinder head gasket assembly (40) of the type for clamping between two mating members to perfect a fluid-tight seal around at least two side-by-side flow passages, said gasket assembly (40) comprising:
a first functional layer (28) comprising a generally planar body (32) having a generally uniform thickness (A); said first layer (28) having at least two side-by-side fully included first openings (34) therein for sealing around the two side-by-side passages; a first bridge portion of said first layer (28) extending in the region between said first openings (34);
a second functional layer (30) comprising a generally planar body (36) having a generally uniform thickness, said second layer (30) fabricated from a metallic material; said second layer (30) having at least two side-by-side fully included second openings (38) therein for sealing around the two side-by-side passages; a second bridge portion of said second layer (30) extending in the region between said second openings (38);
said first (28) and second (30) layers overlying one another such that said respective first (34) and second (38) openings are generally aligned along a respective laterally extending axes (D);
said first layer (28) including a first sealing bead (42) spaced apart from and surrounding each of said first openings (34); each of said first sealing beads (42) including a crest (46) laterally offset from said planar body (32) of said first layer (28);
said second layer (30) including a second sealing bead (44) spaced apart from and surrounding each of said second openings (38); each of said second sealing beads (44) including a crest (48) laterally offset from said planar body (36) of said second layer (30);
said first sealing beads (42) each being laterally offset from said first layer (28) in a direction opposite to the lateral offset of said second sealing beads (44) relative to said second layer (30);
said first layer (28) including a first rim (50) directly adjacent each of said first openings (34); said first rims (50) extending laterally from said planar body (32) of said first layer (28) to respective first terminal edges; said first rims (50) each having a first rim height (C) measured axially at said first openings (34);
said second layer (30) including a second rim (52) directly adjacent each of said second openings (38); said second rims (52) extending laterally from said planar body (36) of said second layer (30) to respective second terminal edges; said second rims (50) each having a second rim height (B) measured axially at said second openings (38);
said first rims (50) closely surrounding a respective one of said second rims (52) in nested overlapping relationships to form respective labyrinth stoppers about each combustion chamber opening (34, 38) and in the regions of said first and second bridge portions.

18. The gasket assembly (40) of claim 17, wherein at least one of said first (28) and second (30) layers includes an elastomer coating (58) covering one side thereof.

19. The gasket assembly (40) of claim 17, wherein at least one intermediate layer (54) is disposed between said first (28) and second (30) layers.
